(19) United States
(12) Patent Application Publication
(10) Pub. No.: US 2010/0161726 A1
(43) Pub. Date: Jun. 24, 2010

(54) Method, Server and Terminal for Broadcasting a Message to a Plurality of Members of a Community

(75) Inventor: Zhongwen Zhu, Saint-Laurent (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/338,143

(22) Filed: Dec. 18, 2008

(51) Int. Cl. G06F 15/16

(52) U.S. Cl. 709/204

(57) ABSTRACT

The invention relates to a method, a server and a terminal for broadcasting a message to a plurality of members of a community. The method comprises the steps of receiving an incoming message, the message comprising a community identifier (ID). The method further comprises identifying community members listed in a contact list of a recipient of the incoming message, with the community ID. The method also comprises the step of forwarding the incoming message to the community members identified in the contact list of the recipient. The messaging server and terminal comprise a receiving module for receiving an incoming message, a processor for identifying community members listed in a contact list of the recipient of the incoming message, with the community ID and a sending module for forwarding the incoming message to the community members identified in the contact list of the recipient.

### TECHNICAL FIELD

The present invention relates to the field of message broadcasting.

### BACKGROUND

Group messaging is one of basic services provided in the Open Mobile Alliance Session Initiation Protocol for Instant Messaging and Presence Leveraging Extensions Instant Messaging (OMA SIMPLE IM). It allows an end user to send a message to a group of persons. The group concept is set up around the end user. There are two kinds of groups: pre-defined group and ad-hoc group.

A pre-defined group is a list of contacts stored in the network, a messaging server, a terminal or another server. An ad-hoc group is a list of contacts formed by the end user when sending out the request. FIG. 1 shows that a pre-defined group 6, 8 or 10 may be embedded in another pre-defined group or ad-hoc group 4. In this case, the groups 6, 8 and 10 embedded in another group 4 are called nested groups.

A community is a grouping of many groups or individuals, such as groups 6, 8, 10 and/or individual users 2, 12, 14. One thing that differentiates a group from a community is that the community is defined by a common community name. Even though OMA SIMPLE IM allows connecting different groups by using nested groups, the concept of community, as defined herein is not supported.

### SUMMARY

It is therefore an object of this invention to provide a method, server and terminal for broadcasting a message to a plurality of members of a community.

According to an aspect of the invention, there is provided a method for broadcasting a message to a plurality of members of a community. The method comprises the step of receiving an incoming message comprising a community identifier (ID). The method also comprises a step of identifying community members listed in a contact list of a recipient of the incoming message, with the community ID. The method further comprises a step of forwarding the incoming message to the community members identified in the contact list of the recipient.

According to another aspect of the invention, there is provided a messaging server (MS) for broadcasting a message to a plurality of members of a community. The MS comprises a receiving module for receiving an incoming message, the message comprising a community identifier (ID). The MS further comprises a processor for identifying community members listed in a contact list of the recipient of the incoming message, with the community ID. The MS also comprises a sending module for forwarding the incoming message to the community members identified in the contact list of the recipient.

According to another aspect of the invention, there is provided a terminal for broadcasting a message to a plurality of members of a community. The terminal comprises a receiving module for receiving an incoming message, said message comprising a community identifier (ID). The terminal also comprises a processor for identifying community members listed in a contact list of the recipient of the incoming message, with the community ID. The terminal further comprises a sending module for forwarding the incoming message to the community members identified in the contact list of the recipient.

### BRIEF DESCRIPTION OF THE DRAWINGS

The objects and advantages of the invention will be understood by reading the detailed description in conjunction with the figures, wherein:

FIG. 1 illustrates an exemplary nested groups of the prior art;

FIG. 2 illustrates a community according to an exemplary embodiment of the invention;

FIG. 3 shows new headers in a Session Initiation Protocol (SIP) MESSAGE according to an exemplary embodiment of the invention;

FIG. 4 is a flowchart illustrating the steps of a method according to an exemplary embodiment of the invention;

FIG. 5 is an exemplary flowchart detailing the step of forwarding of FIG. 4;

FIG. 6 illustrates the traffic flow between community members according to an exemplary embodiment of the invention;

FIG. 7 is a block diagram of a messaging server according to an exemplary embodiment of the invention; and

FIG. 8 is a block diagram of a terminal according to an exemplary embodiment of the invention.

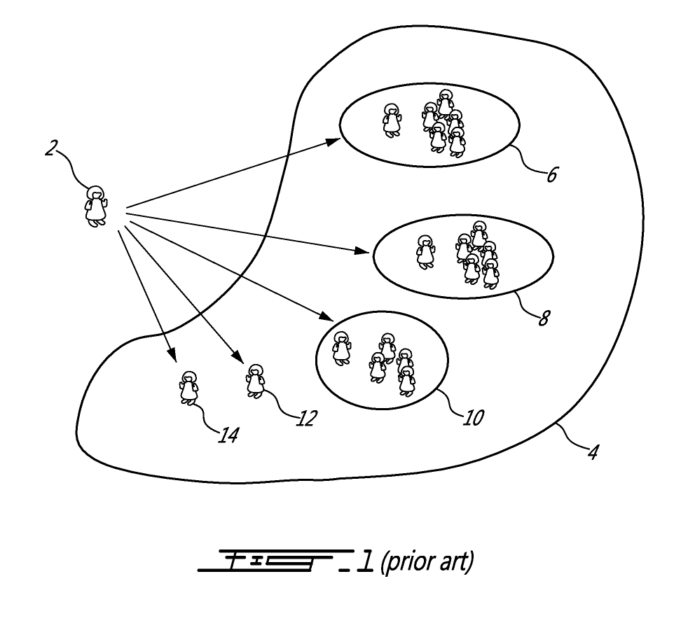

### DETAILED DESCRIPTION

The various features of the invention will now be described with reference to the figures. These various aspects are described hereafter in greater detail in connection with an exemplary embodiment and example to facilitate an understanding of the invention, but should not be construed as limited to this embodiment. Rather, this embodiment is provided so that the disclosure will be thorough and complete, and will fully convey the scope of the invention to those skilled in the art.

Many aspects of the invention are described in terms of sequences of actions or functions to be performed by elements of a computer system or other hardware capable of executing programmed instructions. It will be recognized that the various actions could be performed by specialized circuits (e.g., discrete logic gates interconnected to perform a specialized function), by program instructions being executed by one or more processors, or by a combination of both. Moreover, the invention may additionally be considered to be embodied within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

The embodiment according to the present invention is described with reference to block diagrams and/or operational illustrations of methods, servers, and computer program products. It is to be understood that each block of the block diagrams and/or operational illustrations, and combinations of blocks in the block diagrams and/or operational illustrations, may be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some steps of a method may be optional and may or may not be executed; these are generally illustrated with dashed lines.

The purpose of the invention is to provide means for broadcasting a message to members of a community.

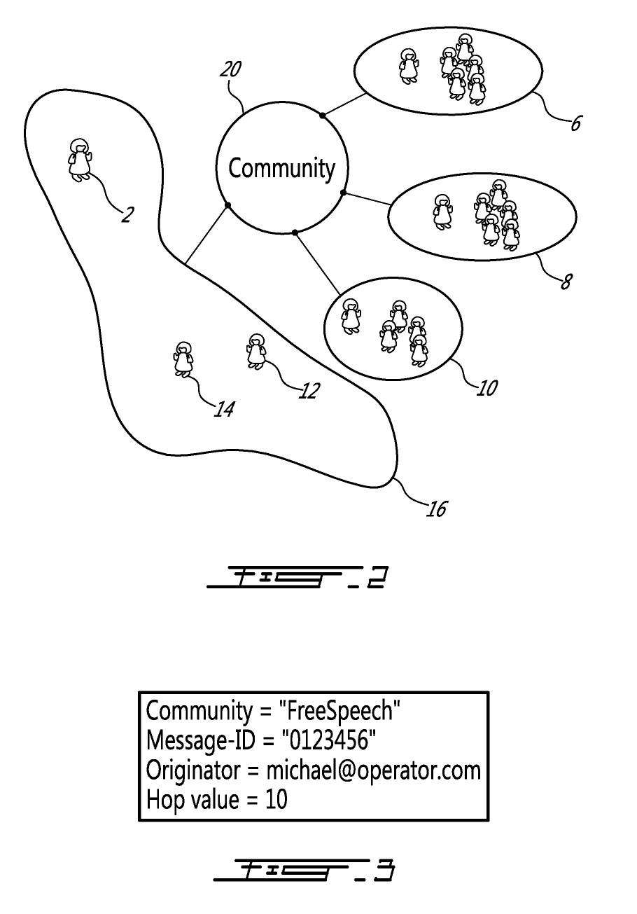

FIG. 2 shows several groups 6, 8, 10 and 16 forming a community 20. Messages that may be exchanged and shared within the community are called community messages.

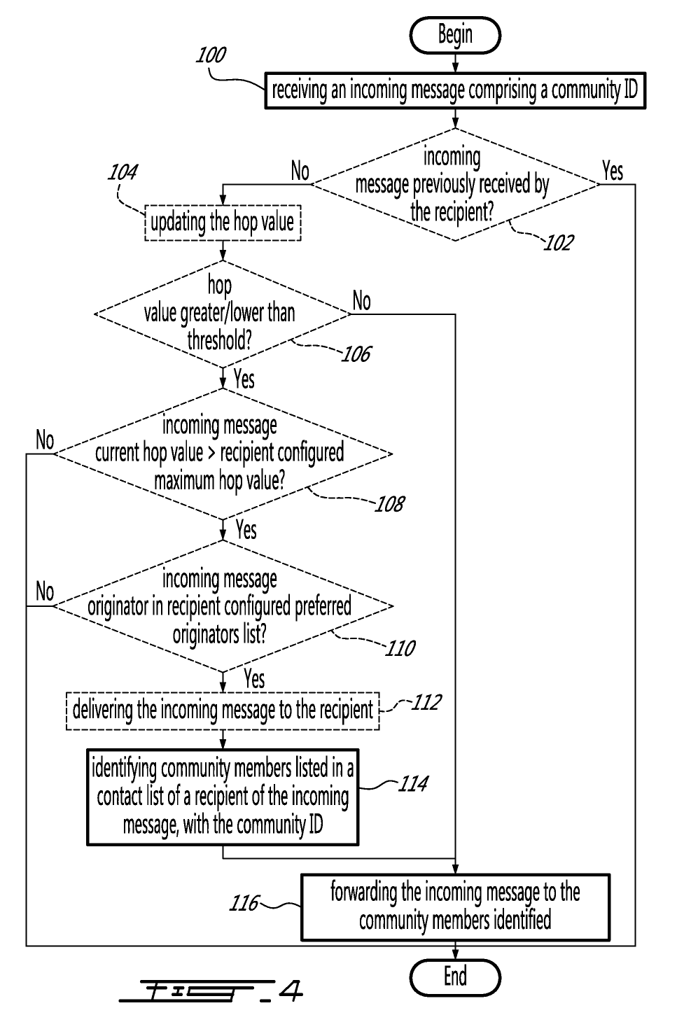

FIG. 3 shows several special identifiers, which may be incorporated as headers in a message, designed to connect different groups together for the distribution of a specific message. For instance, the identifier of a community may be a community name or a feature shared by different groups. The feature may be, for example, a service offered by an operator or by many operators. For instance, a community may comprise all users subscribing to a specific service, such as internet access, or subscribing to a specific service offered only by a specific operator. The community identifier may also take any other form such as a number or any other means of identification, as it would be apparent to a person skilled in the art. Furthermore, it may also be related to an operator, a manufacturer or model of user device, etc.

For example, when the present invention is applied to the Internet Protocol (IP) Multimedia Subsystem (IMS), in order to send a community message, at least the first of the following headers, which may be embodied as shown in FIG. 3, may be added to a SIP MESSAGE:
a community identifier (ID) header, used to carry the community name or feature name, which is used to identify the targeted community;
a message identifier header used to carry the message identity and useful to verify if a message has already been delivered to the a user;
a message originator header identifying the originator or sender of the message; and
a hop value header used to control the number of times the message may be forwarded, from one user to a next user (e.g. forming a chain of users), in the community.

FIG. 4 illustrates the steps of a method for broadcasting a message to a plurality of members of a community. A community member may be a single user, a group of users, a virtual entity, etc. The message may of course be of any type, such as email, Short Message Service (SMS), Multimedia Messaging service (MMS), Instant Messaging (IM), etc. The method comprises the steps of receiving, at step 100, an incoming message comprising a community identifier (ID). The community identifier may be part of the header of the message. The method also comprises the step of identifying, at step 114, community members listed in a contact list of a recipient of the incoming message, with the community ID, i.e. users pertaining to the same community and being identified as such with the community ID. The method further comprises the step of forwarding, at step 116, the incoming message to the community members identified in the contact list of the recipient.

At least one of the community members listed in the contact list of the recipient may be a group of users. Of course, the group of users and/or its list of users may be identified with the community ID. In this case, the incoming message may be forwarded to each user of the group of users.

The incoming message may comprise a message identifier. In such a case, the method may further comprise, before the step of forwarding 116, the step of determining, at step 102, if the incoming message was previously received by the recipient, by comparing the message identifier with corresponding IDs of messages previously received by that recipient. If the incoming message was not previously received by the recipient, the method may also comprise the step of delivering, at step 112, the incoming message to the recipient. Depending if the method is executed in a server or in a terminal, the step of delivering may mean two different things. It may mean delivering the message to the terminal, in the case where the method is executed in a server. While it may mean storing the message for later user and/or displaying the message to the user, in the case where the method is executed in a terminal.

The incoming message may further comprise a hop value. A hop value is preferably indicative of a number of times the incoming message should be forwarded from one user to the next user or sent. The hop value is preferably an integer. If a hop value is present in the incoming message, the step of forwarding may further comprise the steps of updating, at step 104, the hop value. The update could take the form of incrementing or decrementing a counter, for example. In a case where the threshold would be zero, the hop value may be a positive integer, decremented at the step of updating, until its value reaches zero. In the case where the threshold would be, for example, a value above zero, the hop value may also be a positive integer, but this time incremented at the step of updating, until its value reaches the threshold. The threshold may be kept in the device, in the server or in the message itself. If the hop value is above or below a threshold, at step 106, then the step of forwarding 116 the incoming message to the community members listed in the contact list of the recipient is executed.

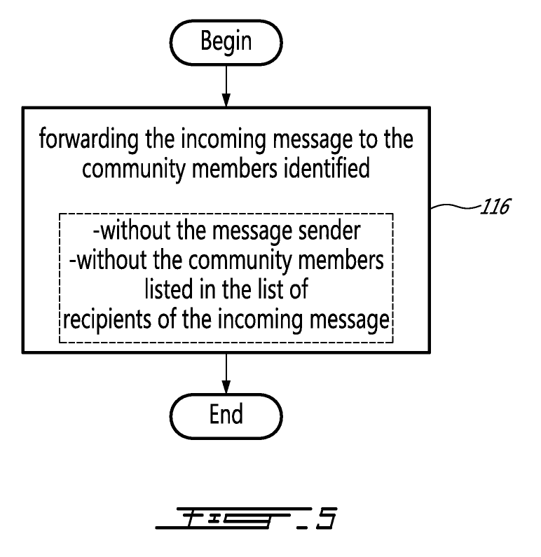

The incoming message may further comprise a message sender. In such a case, as illustrated at FIG. 5, the step of forwarding, at step 116, may further comprise forwarding the incoming message to the community members identified in the contact list of the recipient, without forwarding the incoming message to the message sender. Furthermore the incoming message may further comprise a list of recipients and the step of forwarding, at step 116, may also comprise forwarding the incoming message to the community members identified in the contact list of the recipient, without forwarding the incoming message to the community members listed in the list of recipients of the incoming message.

The incoming message may further comprise a current number of hops. The current number of hops preferably represents the number of times a message has already been forwarded from one user to the next user. The current number of hops may take many forms, as it would be apparent to a person skilled in the art. If a current number of hops is present in the incoming message, the method may further comprise a step, before the step of delivering 112, of comparing the current number of hops with a recipient configured maximum number of hops and if the current number of hops is smaller or equal to the maximum number of hops, at step 108, delivering 112, the incoming message to the recipient. The recipient configured maximum number of hops is a value beyond which a user does not want to receive a message anymore. This value may be stored in a user profile, in a device or a server, for example. For example, a user may choose to discard any massage having been forwarded more than 20 times. In the same manner, a threshold on the date or time could also be set, i.e. if a message was first sent more than a certain number of days ago, the message would be discarded. Other thresholds could also be implemented as it would be apparent to a person skilled in the art.

The incoming message may further comprise a message originator. In such a case, the method may further comprise, before the step of delivering 112, the step of searching the incoming message originator in a recipient configured preferred originators list and if the message originator is present in the preferred originators list, at step 110, delivering 112, the incoming message to the recipient. This step provides the user a way to select a list of senders from whom he may allow to receive incoming community messages.

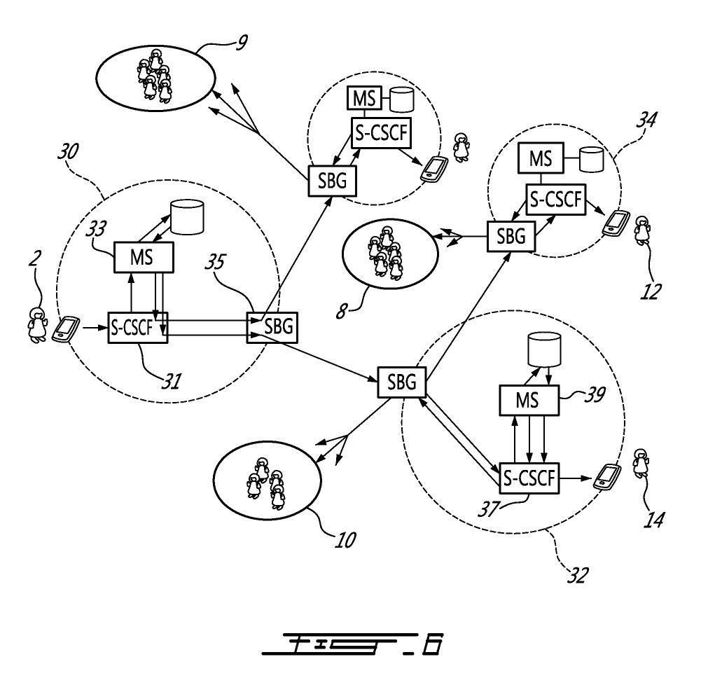

The next figure, FIG. 6, shows an example of traffic flow generated by community messaging. In this example, a message is originated by user 2, which has user 14, group 9 and group 10, all pertaining to the same community, in his contact list. The message is destined to reach the community identified, and is sent to these users and groups. In a second step, the message is forwarded, by user 14, which has user 12 and group 8 in his contact list, to these users. Therefore, for example, user 2 sends a message to a pre-defined group stored in the Internet Protocol (IP) Multimedia Subsystem (IMS) core network of his operator's network 30. The message is relayed to the Serving Call Session Control Function (S-CSCF) 31 at the originating side 30. The S-CSCF 31 forwards the message to the messaging server (MS) 33 that expands a group to a list of recipients. It is assumed that no nested group is used. The MS then sends a SIP MESSAGE to the list of recipients, user 14 and groups 9 and 10, via the S-CSCF 31 and through the Session Border Gateway (SBG) 35.

At the terminating side 32, for user 14, the S-CSCF 37 forwards the message to the MS 39, which tries to retrieve the following information from the received message:
the community ID;
the message identifier;
the originator of the message; and
the hop value.

If the hop value is equal to zero, in this exemplary embodiment, it means that it is last station for this message. The hop value is used to control the scope or range of spreading of the community message i.e. the number of times the message is forwarded.

The messaging server 39 then checks if the same message has been received before by each of user 14 and group 10, using the message identifier. If it has, the message is discarded. Otherwise the message is delivered to user 14 and to users of group 10. This step is designed to avoid delivering the same message twice to the same user.

In this exemplary embodiment, if the hop value is not equal to zero, it is reduced by one. Reducing the hop value by one each time the message is received is useful for stopping the transmission of the message from one user to the next user, once the hop value reaches a value of zero. In time, the hop value reaches the threshold, the condition of step 106 is not met and the broadcast of the message stops. At the next step, the messaging server searches all the groups or users that may be present in the contact list of user 14 or in the contact lists of the users of group 10 to see if any belong to the community identified in the received message.

If such users or groups exist, as it is the case for user 14, the messaging server expands these groups into a list of recipients and compares them with the recipient list from the received incoming message. It then forms an outgoing recipient list containing only recipients of the community not having received the incoming message.

The messaging server forwards the message using the newly formed outgoing recipients list, including user 12 and group 8 in operator 34 as shown in FIG. 6. The procedure in the terminating network 34 follows the steps described previously.

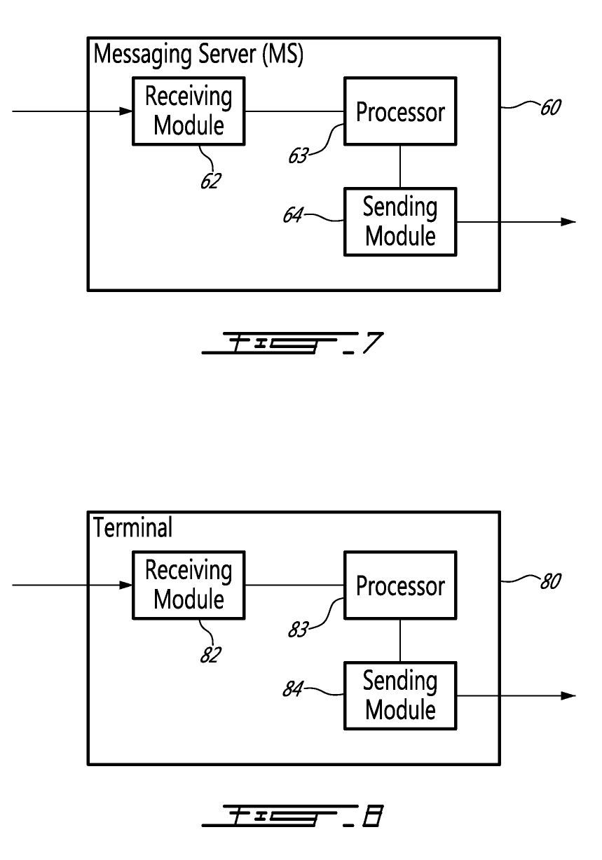

FIG. 7 shows a block diagram of a messaging server (MS) 60 for broadcasting a message to a plurality of members of a community. The MS 60 comprises a receiving module 62 for receiving an incoming message, the incoming message comprising a community identifier (ID). The MS further comprises a processor 63 for identifying community members listed in a contact list of the recipient of the incoming message, with the community ID. The MS 60 further comprises a sending module 64 for forwarding the incoming message to the community members identified in the contact list of the recipient. Of course, the server, with its components as illustrated, and with further components if needed, as it would be apparent to a person skilled in the art, is able to execute the method described hereinabove.

FIG. 8 shows a block diagram of a terminal 80 for broadcasting a message to a plurality of members of a community. The terminal 80 may be a server, a computer, a cell phone, a smart phone, or any other user device. The terminal 80 comprises a receiving module 82 for receiving an incoming message, the incoming message comprising a community identifier (ID). The terminal further comprises processor 83 for identifying community members listed in a contact list of the recipient of the incoming message, with the community ID. The terminal 80 further comprises a sending module 84 for forwarding the incoming message to the community members identified in the contact list of the recipient. Of course, the terminal, with its components as illustrated, and with further components if needed, as it would be apparent to a person skilled in the art, is able to execute the method described hereinabove.

One of the many advantages of the invention is that it provides a mechanism to share a social message with a community in a telecommunications network. It is also advantageous in that it provides the end user with a more efficient way to communicate within a community or social network. Yet another advantage is that it further allows a user to contact other users susceptible to have common interests and to share information with theses users. It advantageously allows users to filter message received in the context of community messaging. Of course, the invention has many other advantages.

The invention has been described with reference to a particular embodiment. However, it will be readily apparent to those skilled in the art that it is possible to embody the invention in specific forms other than those of the embodiment described above. The described embodiment is merely illustrative and should not be considered restrictive in any way. The scope of the invention is given by the appended claims, rather than the preceding description, and all variations and equivalents that fall within the range of the claims are intended to be embraced therein.

1. A method for broadcasting a message to a plurality of members of a community, comprising the steps of:
receiving an incoming message comprising a community identifier (ID);
identifying community members listed in a contact list of a recipient of the incoming message, with the community ID; and
forwarding the incoming message to the community members identified in the contact list of the recipient.

2. The method of claim 1, wherein at least one of the community members listed in the contact list of the recipient is a group of users and wherein the incoming message is forwarded to each user of the group of users.

3. The method of claim 1, wherein the incoming message further comprises a message identifier, the method further comprising, before the step of forwarding, the steps of:
determining if the incoming message was previously received by the recipient, by comparing the message identifier and the recipient with corresponding identifiers and recipients of messages previously received; and
delivering the incoming message to the recipient when the incoming message was not previously received by the recipient.

4. The method of claim 1, wherein the incoming message further comprises a hop value, said hop value being indicative of a number of times the incoming message is to be forwarded from one user to a next user, and wherein the step of forwarding further comprises the steps of:
updating the hop value; and
forwarding the incoming message to the community members listed in the contact list of the recipient when the hop value is above a threshold.

5. The method of claim 1, wherein the incoming message further comprises a hop value, said hop value being indicative of a number of times the incoming message should be forwarded from one user to a next user, and wherein the step of forwarding further comprises the steps of:
updating the hop value; and
forwarding the incoming message to the community members listed in the contact list of the recipient when the hop value is below a threshold.

6. The method of claim 1, wherein the incoming message further comprises a message sender and wherein the step of forwarding further comprises forwarding the incoming message to the community members listed in the contact list of the recipient, without forwarding the incoming message to the message sender.

7. The method of claim 1, wherein the incoming message further comprises a list of recipients and wherein the step of forwarding further comprises forwarding the incoming message to the community members listed in the contact list of the recipient, without forwarding the incoming message to the community members listed in the list of recipients of the incoming message.

8. The method of claim 3, wherein the incoming message further comprises a current number of hops, said current number of hops being indicative of a number of times the message has already been forwarded from one user to a next user, and further comprising, before the step of delivering, the step of comparing the current number of hops with a recipient configured maximum number of hops and when the current number of hops is smaller or equal to the maximum number of hops, delivering the incoming message to the recipient.

9. The method of claim 1, wherein the incoming message further comprises a message originator and further comprising, before the step of delivering, the step of searching the incoming message originator in a recipient configured preferred originators list and when the message originator is present in the preferred originators list, delivering the incoming message to the recipient.

10. A messaging server (MS) for broadcasting a message to a plurality of members of a community comprising:
a receiving module for receiving an incoming message, said message comprising a community identifier (ID);
a processor for identifying community members listed in a contact list of the recipient of the incoming message, with the community ID; and
a sending module for forwarding the incoming message to the community members identified in the contact list of the recipient.

11. The messaging server of claim 10, wherein at least one of the community members listed in the contact list of the recipient is a group of users and wherein the forwarding module forwards the incoming message to each user of the group of users.

12. The messaging server of claim 10, wherein the incoming message further comprises a message identifier, wherein the processor further determines if the incoming message was previously received by the recipient, by comparing the message identifier and the recipient with corresponding IDs and recipients of messages previously received and wherein the sending module further delivers the incoming message to the recipient when the incoming message was not previously received by the recipient.

13. The messaging server of claim 10, wherein the incoming message further comprises a hop value, said hop value being indicative of a number of time the incoming message should be forwarded from one user to a next user, wherein the processor further updates the hop value and wherein the sending module forwards the incoming message to the community members listed in the contact list of the recipient when the hop value is above a threshold.

14. The messaging server of claim 10, wherein the incoming message further comprises a hop value, said hop value being indicative of a number of times the incoming message should be forwarded from one user to a next user, wherein the processor further updates the hop value; and wherein the sending module forwards the incoming message to the community members listed in the contact list of the recipient when the hop value is below a threshold.

15. The messaging server of claim 10, wherein the incoming message further comprises a message sender and wherein the sending module further forwards the incoming message to the community members listed in the contact list of the recipient, without forwarding the incoming message to the message sender.

16. The messaging server of claim 10, wherein the incoming message further comprises a list of recipients and wherein the sending module further forwards the incoming message to the community members listed in the contact list of the recipient, without forwarding the incoming message to the community members listed in the list of recipients of the incoming message.

17. The messaging server of claim 12, wherein the incoming message further comprises a current number of hops, said current number of hops being indicative of a number of times the message has already been forwarded from one user to a next user, and wherein the processor further compares the current number of hops with a recipient configured maximum number of hops and when the current number of hops is smaller or equal to the maximum number of hops, the sending module delivers the incoming message to the recipient.

18. The messaging server of claim 10, wherein the incoming message further comprises a message originator and wherein the processor further searches the incoming message originator in a recipient configured preferred originators list and when the message originator is present in the preferred originators list, the sending module delivers the incoming message to the recipient.

19. A terminal for broadcasting a message to a plurality of members of a community comprising:
a receiving module for receiving an incoming message, said message comprising a community identifier (ID);
a processor for identifying community members listed in a contact list of the recipient of the incoming message, with the community ID; and
a sending module for forwarding the incoming message to the community members identified in the contact list of the recipient.

20. The terminal of claim 19, wherein at least one of the community members listed in the contact list of the recipient is a group of users and wherein the forwarding module forwards the incoming message to each user of the group of users.

21. The terminal of claim 19, wherein the incoming message further comprises a message identifier, wherein the processor further determines if the incoming message was previously received by the recipient, by comparing the message identifier and the recipient with corresponding IDs and recipients of messages previously received and wherein the sending module further delivers the incoming message to the recipient when the incoming message was not previously received by the recipient.

22. The terminal of claim 19, wherein the incoming message further comprises a hop value, said hop value being indicative of a number of time the incoming message should be forwarded from one user to a next user, wherein the processor further updates the hop value and wherein the sending module forwards the incoming message to the community members listed in the contact list of the recipient when the hop value is above a threshold.

23. The terminal of claim 19, wherein the incoming message further comprises a hop value, said hop value being indicative of a number of times the incoming message should be forwarded from one user to a next user, wherein the processor further updates the hop value; and wherein the sending module forwards the incoming message to the community members listed in the contact list of the recipient when the hop value is below a threshold.

24. The terminal of claim 19, wherein the incoming message further comprises a message sender and wherein the sending module further forwards the incoming message to the community members listed in the contact list of the recipient, without forwarding the incoming message to the message sender.

25. The terminal of claim 19, wherein the incoming message further comprises a list of recipients and wherein the sending module further forwards the incoming message to the community members listed in the contact list of the recipient, without forwarding the incoming message to the community members listed in the list of recipients of the incoming message.

26. The terminal of claim 21, wherein the incoming message further comprises a current number of hops, said current number of hops being indicative of a number of times the message has already been forwarded from one user to a next user, and wherein the processor further compares the current number of hops with a recipient configured maximum number of hops and when the current number of hops is smaller or equal to the maximum number of hops, the sending module delivers the incoming message to the recipient.

27. The terminal of claim 19, wherein the incoming message further comprises a message originator and wherein the processor further searches the incoming message originator in a recipient configured preferred originators list and when the message originator is present in the preferred originators list, the sending module delivers the incoming message to the recipient.
